(19) United States
(12) Patent Application Publication
(10) Pub. No.: US 2012/0260897 A1
(43) Pub. Date: Oct. 18, 2012

(54) Internal Combustion Engine

(75) Inventors: Alan W. Hayman, Romeo, MI (US); Rodney E. Baker, Fenton, MI (US); Robert S. McAlpine, Lake Orion, MI (US)

(73) Assignee: GM GLOBAL TECHNOLOGY OPERATIONS LLC, Detroit, MI (US)

(21) Appl. No.: 13/181,981

(22) Filed: Jul. 13, 2011

Related U.S. Application Data
(60) Provisional application No. 61/474,978, filed on Apr. 13, 2011.

(51) Int. Cl. F02M 25/07; F02D 41/00

(52) U.S. Cl. 123/568.2

(57) ABSTRACT

An internal combustion engine comprises a working cylinder, an EGR cylinder, an intake system for supplying a combustion air charge to the cylinders, a first exhaust system for removing exhaust gas from the working cylinder and to the atmosphere, a second exhaust system for removing exhaust from the EGR cylinder and supplying the exhaust gas through an EGR supply conduit to the intake system, an EGR bypass conduit extending between and fluidly connecting the EGR supply conduit and the first exhaust treatment system, a first valve assembly disposed in the EGR supply conduit between the intake system and an inlet of the EGR bypass conduit and a second valve assembly disposed in the EGR bypass conduit.

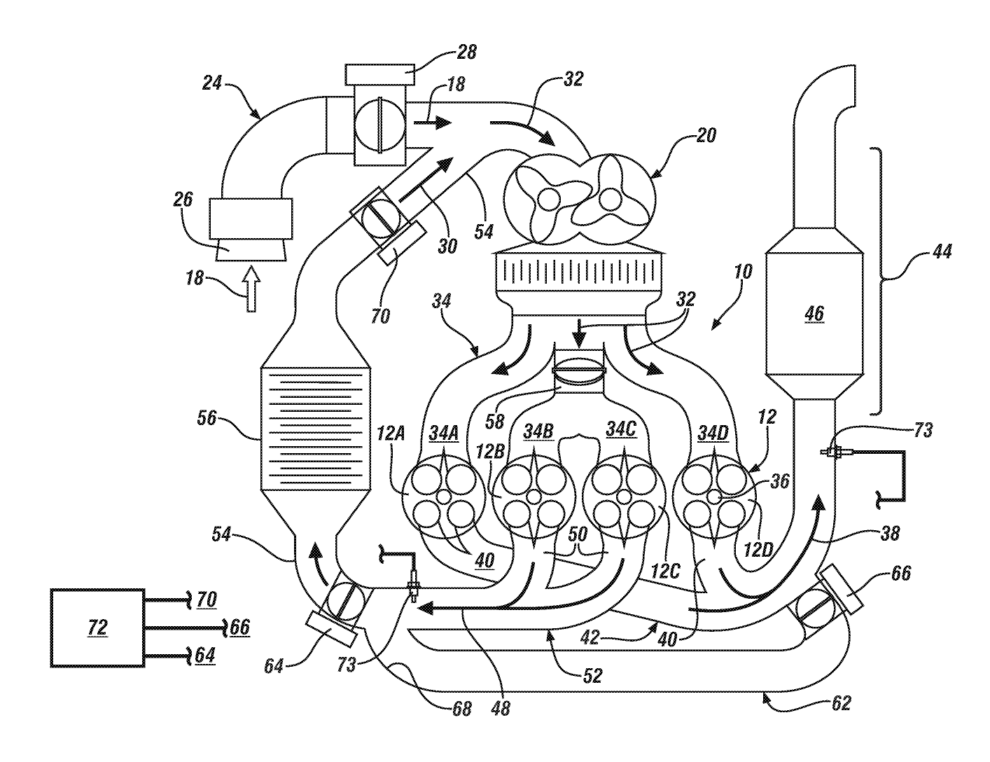

### CROSS-REFERENCES TO RELATED APPLICATIONS

This patent application claims priority to U.S. Patent Application Ser. No. 61/474,978 filed Apr. 13, 2011 which is hereby incorporated herein by reference in its entirety.

### FIELD OF THE INVENTION

Exemplary embodiments of the invention relate to internal combustion engines having exhaust gas recirculation systems and, more particularly to an internal combustion engine having an engine cylinder dedicated to the production and supply of recirculated exhaust gas to another cylinder of the engine and apparatus for delivery thereto.

### BACKGROUND

With increased focus on vehicle economy, automotive manufacturers are turning to smaller, lighter vehicles and unique vehicle powertrains to boost efficiency. Recirculated exhaust gas (“EGR”) is utilized in most conventional internal combustion engines to assist in the reduction of throttling losses at low loads, and to improve knock tolerance and reduce the level of oxides of nitrogen (“NOₓ”) in the exhaust gas. EGR is especially important as an emissions reducer in internal combustion engines that run lean of stoichiometry and are, as such, prone to emitting higher levels of NOₓ emissions.

One proposition that has been considered in the construction of internal combustion engine systems is to utilize one or a plurality of cylinders as a dedicated EGR source. Specifically, in a four cylinder engine for instance, two or three of the four cylinders will run at normal air, fuel and EGR mixtures (working cylinders). The exhaust gas produced by these cylinders will exit the internal combustion engine as exhaust gas and be treated in an exhaust gas treatment system prior to its release to the atmosphere. One or two of the four cylinders is operated at customized levels of air and fuel (EGR cylinders); as may be determined by an engine controller that is in signal communication with various engine, vehicle and exhaust system sensors. The exhaust gas produced in these cylinders is transferred to the intake system to provide EGR. Such a configuration allows for richer EGR, which contains higher levels of Hydrogen, thereby improving knock resistance, fuel consumption and combustion stability while still allowing stoichiometrically combusted exhaust gas to be maintained in the exhaust gas treatment system for compatibility with the catalytic treatment devices.

In some modes of operation, the system designs described may compromise the operating stability of the internal combustion engine. Such modes may be following a cold start, extremely light load (ex. idle speed), high load and high load at high engine speed.

### SUMMARY

In an exemplary embodiment an internal combustion engine comprises a working cylinder, an EGR cylinder, an intake system for supplying a combustion air charge to the cylinders, a first exhaust system for removing exhaust gas from the working cylinder and to the atmosphere, a second exhaust system for removing exhaust from the EGR cylinder and supplying the exhaust gas through an EGR supply conduit to the intake system, an EGR bypass conduit extending between and fluidly connecting the EGR supply conduit and the first exhaust treatment system, a first valve assembly disposed in the EGR supply conduit between the intake system and an inlet of the EGR bypass conduit and a second valve assembly disposed in the EGR bypass conduit.

The above features and advantages, and other features and advantages of the invention are readily apparent from the following detailed description of the invention when taken in connection with the accompanying drawing.

### BRIEF DESCRIPTION OF THE DRAWINGS

Other objects, features, advantages and details appear, by way of example only, in the following detailed description of the embodiments, the detailed description referring to the drawing in which:

The FIGURE is a schematic view of portions an internal combustion engine system embodying features of the invention.

### DESCRIPTION OF THE EMBODIMENTS

The following description is merely exemplary in nature and is not intended to limit the present disclosure, its application or uses.

The invention described in various embodiments herein comprises a novel apparatus and method for the supply of exhaust gas to the cylinders of an internal combustion engine (i.e. regenerated exhaust gas “EGR”). As discussed above, the EGR is useful in maintaining several performance parameters of the internal combustion engine including maintaining reduced levels of oxides of nitrogen (“NOₓ”), which is a regulated exhaust constituent, and is more prevalent in engines that are operated on the lean side (i.e. excess oxygen) of stoichiometry. The basic premise of the invention is to provide an internal combustion engine with two configurations of cylinder(s); a first “working type” and a second “EGR type”. While all cylinders are operated in a manner that provides work output from the engine, the first, working type is operated at normal air/fuel ratios that deliver optimum power and appropriate exhaust emissions to an exhaust treatment system. The second, EGR type is operated in a manner that may not necessarily deliver optimum power and appropriate exhaust emissions but, instead delivers optimal EGR directly to the intake ports of the first, working type of cylinders. Mechanically, the exhaust ports of the second, EGR type of cylinders is fluidly connected to the intake system of the internal combustion engine and not to the exhaust treatment system. The path for the exhaust from these cylinders to the exhaust treatment system is by recirculation through the intake system and through the first, working type of cylinders.

Optimization of the internal combustion engine preferably will result in a consistent, reliable supply of EGR to the working cylinders, at the appropriate time and during appropriate operating modes, for optimal performance of the working cylinder(s). As should be apparent, it is contemplated that the invention is applicable to many configurations of internal combustion engines without deviating from the scope thereof. For example, a 2-cylinder engine may comprise one working cylinder and one EGR cylinder, a 3-cylinder engine may comprise two working cylinders and one EGR cylinder operating on a two stroke cycle or a 4-stroke cycle, a 4-cylinder engine may comprise two or three working cylinders and one or two EGR cylinders, a 6-cylinder engine may comprise up to three working cylinders and three EGR cylinders an 8-cylinder engine may comprise up to four working cylinders and four EGR cylinders, etc.

Referring now to the FIGURE, and for purposes of description only, an exemplary embodiment of the invention is directed to an in-line 4-cylinder internal combustion engine system 10 comprising a plurality of engine cylinders 12. As indicated, in the embodiment illustrated, the internal combustion engine system 10 is an in-line internal combustion engine including four engine cylinders 12, however the configuration may also include any number of cylinders (to be described in further detail) as well as other configurations such as V-configured, horizontally opposed and the like, without affecting the application of the invention thereto.

Referring to the engine cylinders 12 in the exemplary embodiment shown, the individual cylinders are numbered cylinder #1, 12A (working cylinder), cylinder #2, 12B (EGR cylinder), cylinder #3 12C (EGR cylinder), and cylinder #4, 12D (working cylinder). Combustion air 18 enters an intake system 24 through inlet 26 and is metered by a throttle body 28 in a known manner. The metered combustion air 18 is mixed with an exhaust gas diluent referred to generally as recirculated exhaust gas or EGR 30 to form a combustion charge 32 comprising a mixture of combustion air 18 and EGR 30.

The combustion charge 32 may be compressed by a compressor 20 which, in the exemplary embodiment shown, is an engine driven supercharger and is delivered to each of the engine cylinders 12 through an intake manifold 34 comprising a plurality of intake runners 34A, 34B, 34C and 34D corresponding to engine cylinders 12A-12D, respectively. The combustion charge 32 is mixed with fuel in the cylinders 12 and is combusted therein. One or more ignition devices such as spark plugs 36 may be located in communication with the cylinders 12 and operate to ignite the fuel/air mixture therein.

In an exemplary embodiment, exhaust gas 38 from the combustion of fuel and combustion charge 32 in the working cylinders 12A and 12D (cylinders #1 and #4) exits the cylinders through the exhaust passages 40 of a first exhaust manifold 42. The exhaust manifold 42 is in fluid communication with an exhaust treatment system 44 that may include one or more exhaust treatment devices (ex. oxidation catalyst device, selective catalyst reduction device, particulate trap, or a combination thereof) 46 for the oxidation, reduction or filtering of exhaust constituents prior to the release of the exhaust gas to the atmosphere. Exhaust gas 48 from the combustion of fuel and combustion charge 32 in the EGR cylinders 12B and 12C (cylinders #2 and #3) exits the cylinders through the exhaust passages 50 of a second exhaust manifold 52. The exhaust manifold 52 is in fluid communication with EGR supply conduit 54 which delivers the exhaust gas as EGR 30 to the intake system 24. An EGR cooler 56 may be disposed within the EGR supply conduit 54 to cool the exhaust gas 48 prior to its reintroduction into the intake system as EGR 30 and mixing with the combustion air 18.

In an exemplary embodiment, the cylinder firing order of the internal combustion engine 10 may be working cylinder #1, 12A, EGR cylinder #3, 12C, working cylinder #4, 12D and EGR cylinder #2, 12B. As a result of this firing order, the cylinders supplying EGR 30 to the intake system 24 (i.e. cylinders 12B and 12C) fire between the combustion events of the working cylinders 12A and 12D thereby providing a consistent flow of EGR 30 to the EGR inlet for delivery to combustion charge 32. As such, the combustion charge 32 comprises a homogeneous mixture of combustion air 18 and EGR 30 when delivered to the cylinders 12 during operation of the internal combustion engine 10.

While the embodiment of the FIGURE just described is illustrated with two working cylinders and two EGR cylinders, in some applications it is contemplated that a lower quantity of overall EGR may be required across the full range of engine operation. In an exemplary embodiment, intake runners 34B and 34C of the intake manifold 34 may include at least one throttle body 58 that, in an exemplary embodiment is electronically controlled by a controller 72. The throttle body 58 is in signal communication with the controller 72 that monitors various engine and exhaust system parameters (such as input from oxygen sensors 73) and adjusts the flow of combustion charge into the EGR cylinders 12B and 12C to thereby adjust the composition of the combustion charge entering the EGR cylinders with the result that the exhaust gas 48 exiting the EGR cylinders is optimized for the working cylinders 12A and 12B.

In an exemplary embodiment, an EGR bypass conduit 62 extends between and fluidly connects the EGR supply conduit 54 and the exhaust treatment system 44 at a location upstream of exhaust treatment device(s) 46. Such location may also include fluid communication with the second exhaust manifold 52. A first valve assembly 64 is disposed in the EGR supply conduit 54 between the intake system 24 and the inlet 68 of the EGR bypass conduit 62. In a similar fashion, a second valve assembly 66 is disposed in the EGR bypass conduit 62.

Referring to TABLE 1, in one exemplary embodiment of a first mode of operation (FULL EGR) of the internal combustion engine 10, the first valve assembly 64 is in an open position to allow exhaust gas 48 to flow through EGR supply conduit 54 and to the intake system 24 for mixing with combustion air 18 while the second valve assembly remains closed to prevent the flow of exhaust gas 48 directly from the EGR cylinders 12B and 12C to the exhaust treatment system 44.

TABLE 1

| | | | THROTTLE | |
|---|---|---|---|---|
| | | | BODY 70 | |
| MODE | VALVE 64 | VALVE 66 | (OPTIONAL) | GAS FLOW |
| FULL EGR | OPEN/MODULATE | CLOSED/MODULATE | OPEN/MODULATE | From EGR cylinders |
| | | | | to inlet |
| IDLE/START | CLOSED/MODULATE | OPEN/MODULATE | CLOSED/MODULATE | All (most) gas |
| | | | | through Exhaust |
| | | | | System |
| HIGH SPEED | CLOSED/MODULATE | OPEN/MODULATE | CLOSED/MODULATE | All (most)gas |
| | | | | through Exhaust |
| | | | | System (for higher |
| | | | | load and speed) |
| PART EGR | OPEN/MODULATE | OPEN/MODULATE | MODULATE | EGR to inlet as |
| | | | | required & to |
| | | | | Exhaust System |

In another exemplary embodiment, during some modes of operation of the internal combustion engine 10, EGR 30 may compromise combustion stability and may not be a desirable component of the combustion charge 32. Such operating modes of the internal combustion engine 10 may include, but are not limited to, cold starts when excess water vapor in the EGR 30 is not desirable in the intake system 24, extremely light loading such as at idle and operation under high loads and under high loads at high engine speeds. In such instances, the internal combustion engine 10 of the invention may be reconfigured to operate without, or with limited EGR 30. In such a second mode of operation (IDLE/START), first valve assembly 64 is in a closed position, or slightly modulated to thereby prevent most or all of the flow of exhaust gas 48 into the EGR supply conduit 54 while the second valve assembly 66 is in an open, or widely modulated position to allow the exhaust gas 48 to flow through the EGR bypass conduit 62 and to the exhaust treatment system 44.

In another exemplary embodiment, in some cases of high loads and high loads and high engine speeds (ex. wide open throttle “(WOT”) it may be beneficial to supply a limited quantity of EGR 30 (i.e. less than during normal engine operation) in the range of 5-17%. In another exemplary embodiment it may be beneficial to supply an even more limited quantity of EGR 30 (i.e. less than during normal engine operation) in the range of 3-12%. Such a lower quantity of EGR 30 may actually allow the internal combustion engine 10 to be operated at a higher compression ratio for greater power and increased fuel efficiency. In such instances, and in an exemplary embodiment, an optional third valve assembly 70 may be disposed in the EGR supply conduit 54 between the intake system 24 and the inlet 68 of the EGR bypass conduit 62. The third valve assembly 70 is preferably configured to allow modulation of the valve member (not shown) to thereby allow the valve assembly to operate in a range between fully open and fully closed (ex. a throttle body-type device). During such a third mode of operation (PART EGR) of the internal combustion engine 10, the first valve assembly 64 is in a generally open position to allow exhaust gas 48 to flow through EGR supply conduit 54 and to the intake system 24 for mixing with combustion air 18 while the second valve assembly also remains generally open to allow the flow of exhaust gas 48 directly from the EGR cylinders 12B and 12C to the exhaust treatment system 44. As the third valve assembly 70 is modulated between a fully open and a fully closed position, a desired quantity of EGR 30 flows to the intake system 24. Backpressure in the EGR supply conduit caused by the modulation of the valve assembly 70 will force the remainder of the exhaust gas 48 to flow through the EGR bypass conduit and to the exhaust gas treatment system 44. While the invention has been described utilizing a third valve assembly 70 to modulate the EGR 30 flowing through the EGR supply conduit, it is contemplated that given proper durability and resolution characteristics, the first, the second or a combination of both valve assemblies 64, 66 may be operated as fully open/fully closed valves, as modulated valves or a combination thereof; thereby dispensing with a third valve assembly 70. Likewise, it is contemplated that given proper durability and resolution characteristics, the third, the second or a combination of both valve assemblies 70,66 may be operated as fully open/fully closed valves, as a modulated valves or a combination thereof; thereby dispensing with a first valve assembly 64.

It is contemplated that the first, second and third valve assemblies 64, 66 and 70 may be electronically controlled. The electronically controlled valve assemblies are in signal communication with the controller 72 that monitors various engine and exhaust system parameters and determines the mode of engine operation and, as such, the proper positioning of the valve assemblies.

Application of the invention allows the direct EGR internal combustion engine 10 to be operated as a standard supercharged internal combustion engine when required. By eliminating, or controlling the amount of EGR delivered to the combustion charge, the dynamic range of the direct EGR internal combustion engine 10 can be increased, allow for greater freedom in the selection of engine displacement and increases in specific output that may be required to meet vehicle or other application performance requirements.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed but that the invention will include all embodiments falling within the scope of the present application.

What is claimed is:

1. An internal combustion engine comprising:
a working cylinder;
an EGR cylinder;
an intake system for supplying a combustion air charge to the cylinders,
a first exhaust system for removing exhaust gas from the working cylinder and to the atmosphere;
a second exhaust system for removing exhaust from the EGR cylinder and supplying the exhaust gas through an EGR supply conduit to the intake system,
an EGR bypass conduit extending between and fluidly connecting the EGR supply conduit and the first exhaust treatment system;
a first valve assembly disposed in the EGR supply conduit between the intake system and an inlet of the EGR bypass conduit; and
a second valve assembly disposed in the EGR bypass conduit.

2. The internal combustion engine of claim 1, wherein during a first mode of operation, the first valve assembly is in an open position to allow exhaust gas flow from the EGR cylinder through the EGR supply conduit and to the intake system, and the second valve assembly is in a closed position to prevent the flow of exhaust gas directly from the EGR cylinder and to the first exhaust treatment system.

3. The internal combustion engine of claim 2, wherein during the first mode of operation the first valve assembly is in a modulated, generally open position and the second valve assembly is in a modulated, generally closed position.

4. The internal combustion engine of claim 2, wherein during a second mode of operation, the first valve assembly is in a closed position to prevent the flow of exhaust gas from the EGR cylinder and into the EGR supply conduit, and the second valve assembly is in an open position to allow exhaust gas from the EGR cylinder to flow through the EGR bypass conduit and to the first exhaust treatment system.

5. The internal combustion engine of claim 4, wherein during the second mode of operation the first valve assembly is in a modulated, generally closed position and the second valve assembly is in a modulated, generally open position.

6. The internal combustion engine of claim 1, further comprising:
a third valve assembly disposed in the EGR supply conduit between the intake system and an inlet of the EGR bypass conduit, and configured to operate in a range between fully open and fully closed.

7. The internal combustion engine of claim 6, wherein the third valve assembly is configured to supply a variable quantity of EGR during a third mode of operation.

8. The internal combustion engine of claim 7, wherein in the third mode of operation, the first valve assembly is in an open position to allow exhaust gas from the EGR cylinder to flow through the EGR supply conduit and to the intake system and the second valve assembly is in an open position to allow exhaust gas to flow directly from the EGR cylinder to the exhaust treatment system.

9. The internal combustion engine of claim 1, wherein the first and second valve assemblies are electronically controlled by a controller that monitors engine and exhaust system parameters, determines the mode of engine operation and the relative position of the valve assemblies, open/closed or modulated between open and closed

10. The internal combustion engine of claim 6, wherein the third valve assembly is electronically controlled by a controller that monitors engine and exhaust system parameters, determines the mode of engine operation and the position of the valve assembly.

11. An internal combustion engine comprising:
a plurality of working cylinders;
a plurality of EGR cylinders;
an intake system for supplying a combustion air charge to the cylinders,
a first exhaust system for removing exhaust gas from the working cylinders and to the atmosphere; and
a second exhaust system for removing exhaust from the EGR cylinders and supplying the exhaust gas through an EGR supply conduit to the intake system,
an EGR bypass conduit extending between and fluidly connecting the EGR supply conduit and the first exhaust treatment system;
a first valve assembly disposed in the EGR supply conduit between the intake system and an inlet of the EGR bypass conduit; and
a second valve assembly disposed in the EGR bypass conduit.

12. The internal combustion engine of claim 11, wherein during a first mode of operation, the first valve assembly is in an open position to allow exhaust gas flow from the EGR cylinders through the EGR supply conduit and to the intake system, and the second valve assembly is in a closed position to prevent the flow of exhaust gas directly from the EGR cylinders and to the first exhaust treatment system.

13. The internal combustion engine of claim 12, wherein during a second mode of operation, the first valve assembly is in a closed position to prevent the flow of exhaust gas from the EGR cylinders to the EGR supply conduit and the second valve assembly is in an open position to allow exhaust gas to flow through from the EGR cylinders to the EGR bypass conduit and to the first exhaust treatment system.

14. The internal combustion engine of claim 11, further comprising:
a third valve assembly disposed in the EGR supply conduit between the intake system and an inlet of the EGR bypass conduit, and configured to operate in a range between fully open and fully closed.

15. The internal combustion engine of claim 14, wherein the third valve assembly is configured to supply a variable quantity of EGR during a third mode of operation.

16. The internal combustion engine of claim 15, wherein in the third mode of operation, the first valve assembly is in an open position to allow exhaust gas from the EGR cylinders to flow through the EGR supply conduit and to the intake system and the second valve assembly is in an open position to allow exhaust gas from the EGR cylinders to flow directly from the EGR cylinders to the exhaust treatment system.

17. The internal combustion engine of claim 11, wherein the first and second valve assemblies are electronically controlled by a controller that monitors engine and exhaust system parameters, determines the mode of engine operation and the position of the valve assemblies.

18. The internal combustion engine of claim 14, wherein the third valve assembly is electronically controlled by a controller that monitors engine and exhaust system parameters, determines the mode of engine operation and the position of the valve assembly.
